(19) United States
(12) Patent Application Publication
(10) Pub. No.: US 2009/0020296 A1
(43) Pub. Date: Jan. 22, 2009

(54) Method for extinguishing a fire in a silo

(76) Inventors: Ron C. Lee, Bloomsbury, NJ (US); Michael Heisel, Pullach (DE); Hans-Rudolf Himmen, Haimhausen (DE)

Correspondence Address: The BOC Group, Inc., 575 MOUNTAIN AVENUE, MURRAY HILL, NJ, 07974-2082, US

(21) Appl. No.: 11/879,911

(22) Filed: Jul. 19, 2007

(51) Int. Cl. A62C 3/00; A62C 3/04; E04H 7/22

(52) U.S. Cl. 169/54; 169/46; 52/192

(57) ABSTRACT

The invention relates to a method for extinguishing burning deposited goods situated in a silo, inert gas being introduced into the silo above the burning deposited goods and off gas being extracted above the burning deposited goods from the silo.

### BACKGROUND OF THE INVENTION

The invention relates to a method for extinguishing burning deposited goods situated in a silo, inert gas being introduced into the silo and off gas being extracted from the silo. The invention further relates to a silo for storing deposited goods having an inlet for inert gas and a vent for extracting off gas from the silo.

It is not uncommon for silos with biomass to have open fires and in particular smouldering fires. Also, biomass always contains highly combustible components. In addition, fermentation of organic residues in biomass produces biogas, which substantially comprises methane, carbon dioxide and water. Said biogas is highly combustible and has a high heating value. Many materials, particularly synthetic materials, are charged electrostatically during friction and may ignite the biogas through electric discharge and form the starting point of a fire in biomass.

The clearances between the biomass in the silo contain air, which provides the oxygen necessary for combustion. However, the biomass is normally tightly stored or compressed, respectively, so that the air inside the biomass may circulate only very restrictedly.

For example, if a fire starts inside the biomass due to the above mentioned mechanisms the aerial oxygen in the clearances will be used up first. However, because of the bad air circulation inside the biomass the amount of oxygen necessary for an open fire is not provided. Therefore, the combustion passes over into a smouldering fire.

In the framework of this application the term “smouldering fire” is understood as an incomplete combustion with insufficient oxygen supply. In a smouldering fire a large amount of hydrogen and carbon monoxide is produced. Both gases are lighter than air and thus rise into the free headroom above the stored biomass, where they can form explosive mixtures with the air collected therein.

From EP-0 133 999 A2 an apparatus for fighting seats of fire inside stored materials is known for supplying the seat of fire with pressurised extinguishing agent by means of a lance.

U.S. Pat. No. 2,006,258 describes a device for blowing an extinguishing gas into a powdery material stored in a container.

Fires in biomass silos or biomass bunkers are particularly dangerous because biomass represents a mixture of very many materials. Amongst them are heavy metals, which can act as a catalyst, and promote for example the shift reaction of carbon monoxide with water to carbon dioxide and hydrogen and thus lead to an increased formation of hydrogen near the seat of fire. In the substoichiometric combustion present in a smouldering fire the seat of fire itself produces hydrogen, carbon monoxide and reduces metals, which could in turn become catalytically effective. Hydrogen as a small and light molecule diffuses quickly throughout the biomass and collects in the headroom of the biomass bunker and can lead to detonating gas reactions together with the aerial oxygen.

Different measures are known for extinguishing such fires. However, in fire fighting with water the danger of explosions in the headroom is not lowered. Furthermore, water often does not reach the seat of fire since it is absorbed by the biomass and does not flow further. Thereby the weight of the biomass can increase such that even the silo or the bunker are destroyed mechanically. Furthermore, many deposited goods are cured with the addition of water such that vacating the silo or bunker after or during the fire fighting is no longer possible. Therefore, water is only employed as an extinguishing agent in fires at or near the surface of the deposited goods.

For this reason fires inside goods are preferably extinguished with inert gases. When flooding a silo with an inert gas the air in the goods is displaced into the headroom. However, the displaced air flowing through the goods may initially temporarily kindle the fire before it is suffocated by the inert gas. This temporary increase in combustion may lead to further seats of fire and smouldering fires. Further, the supplied inert gas may raise dust, drastically increasing the danger of dust explosions.

In U.S. Pat. No. 6,199,493 B1 it is proposed to introduce an inert gas from below into the silo, when storing waste in a silo, such that the inert gas, particularly nitrogen or carbon dioxide, flows through the waste and can be extracted at the upper end of the silo. Thus, the entire inside of the silo is to be inerted.

Using carbon dioxide as an inert gas has the advantage of collecting in the lower part of the silo because it is heavier than air. In the case of a fire in the silo the uplift due to the convection through hot flames and gravity act against each other such that carbon dioxide remains at the seat of fire and suffocates the fire.

However, it has now been discovered that carbon dioxide is not inert under the conditions of a smouldering fire but can be decomposed and reduced to CO according to Boudouard's equilibrium. Since CO itself is combustible and, furthermore toxic, employing carbon dioxide as an extinguishing agent is not harmless.

Nitrogen behaves in an inert way as an extinguishing agent but it is lighter than air and therefore rises quickly through the biomass and the goods deposited in the silo, respectively. In doing so nitrogen draws further air, whereby the fire may initially even be kindled and an increased combustion may occur. This, in turn, leads to raised temperatures which evoke further smouldering fires and may form sparks which, in turn, can become sources of danger.

Therefore, it is an object of the invention to show a method for fighting fires in silos which avoids the above mentioned disadvantages.

### SUMMARY OF THE INVENTION

This object is solved by a method of the above type, whereby inert gas is introduced into the silo above the burning deposited goods and off gas is extracted above the burning deposited goods from the silo.

Within the framework of this description the term “silo” is understood as a substantially closed storage container for deposited goods, for example bulk goods from biomass, e.g. corn, animal feed, pellets or also waste or cement. The silo may be of a tower-like, often cylindrical design.

During fermentation of biomass biogas is produced, which is typically made up of about 60% from CH₄, residual CO₂ and water. Said gas is highly combustible and has a high heating value. Many materials, especially synthetic materials, charge electrostatically during friction. In biomass, waste or storage silos friction can for example be produced by dispersed particles in a fire and ignite the burnable gas through electric discharge.

Explosions in silos have so far for the most part been interpreted as explosions of biogas or as dust explosions. Research has now shown that a far bigger danger comes from hydrogen, which is produced in a smouldering fire in a silo. As a small molecule, hydrogen can diffuse particularly well through biomass or deposited goods and collect in the headroom of the silo. There, the hydrogen can react easily with the existing air.

Explosion limits for hydrogen and air mixtures are very high, and particularly between 4.0-vol % hydrogen and 74-vol % hydrogen in air at room temperature there is a non-negligible danger of explosion. Up to an oxygen content of as low as 3.4% the air and hydrogen mixture at room temperature is still combustible. Therefore such concentration ranges must be inhibited.

### DETAILED DESCRIPTION OF THE INVENTION

The method according to the invention therefore aims, on the one hand, at eliminating the production of hydrogen in the silo as quickly as possible and, on the other hand, at minimising the danger of sparks reaching the headroom of the silo.

For this inert gas is introduced into the silo above the burning deposited goods and off gas is extracted above the burning deposited goods from the silo according to the invention.

Unlike the method known from U.S. Pat. No. 6,199,493 B1 the inert gas is introduced from above into the silo. In this way the dispersion of sparks in the direction of the headroom of the silo is substantially lowered, in most cases even completely eliminated. Furthermore, the existing sparks have to rise through the inert gas to the top into the headroom where they are cooled down by the inert gas. The temperature of the sparks is thus lowered to such an extent that they no longer present a source of ignition when they reach the headroom.

By introducing inert gas from above according to the invention air is displaced underneath the introduction site. Through this the oxygen available for combustion in the silo is reduced very quickly. The effect is reinforced through the fire, which uses oxygen. Thereby gas, which has to be the inert gas since other gases have no access to the silo, is pulled towards the seat of fire.

According to the invention the off gas is extracted above the burning deposited goods from the silo. In this manner no current or air and gas recirculation, respectively, which would pull oxygen towards the seat of fire, is produced in the deposited goods.

Preferably, carbon dioxide is introduced into the silo for extinguishing the seat of fire. In the area of the seat of fire the air is depleted of oxygen thereby freeing volume, which is replaced by the carbon dioxide, which is heavier compared to air. Thereby an inert atmosphere suffocating the fire is produced underneath the introduction site of carbon dioxide and particularly underneath the seat of fire.

Further it has been shown that by adding carbon dioxide from above according to the invention lowers the reduction of carbon dioxide in the toxic and flammable carbon monoxide considerably compared to introducing carbon dioxide from underneath into the silo. The reason for this is that carbon dioxide introduced from below has to rise to the top through the seat of fire, thereby initially kindling the fire and leading to a release of large amounts of heat, whereby, in turn, carbon dioxide gas is heated. The Boudouard reaction plays an important role above 900° C. only. Conducting carbon dioxide through the seat of fire therefore results in the formation of additional carbon monoxide. Inert gas introduced from above, on the other hand, does not kindle the fire; in fact, it is heated by the rising combustion gases but does by far not reach 900° C. Therefore the formation of carbon monoxide does not happen according to the Boudouard reaction.

Basically, carbon dioxide may also be introduced in liquid form and sprayed via a nozzle, whereby snow is formed from carbon dioxide. Liquid carbon dioxide is usually stored at temperatures between −20° C. and +20° C. and corresponding equilibrium pressures between 20, bar, abs and 57, bar, abs. At a pressure below 5.2 bar, abs the liquid phase of carbon dioxide does not exist. Thus, when relaxing liquid carbon dioxide to ambient pressure a mixture of carbon dioxide gas and solid carbon dioxide snow is produced. When relaxing liquid carbon dioxide into the silo the carbon dioxide snow will deposit on top of the biomass and thus prevent sparks from entering the headroom of the silo. Furthermore, the introduction site and its surroundings will be cooled down through the addition of liquid or solid carbon dioxide, whereby the fire is further suppressed and its spreading prevented. Particularly, sparks are cooled and their amount is reduced, whereby the danger of explosion is drastically lowered.

Vaporisation of the supplied liquid carbon dioxide is linked with a strong expansion of volume. Since the silo is closed underneath and the gases produced during the smouldering fire rise to the top the gaseous carbon dioxide can expand below in a restricted manner only and will therefore substantially saturate the deposited goods above the seat of fire. Through this the expansion of the fire to the top is very constricted and in many cases even completely prevented. Potentially rising sparks have to pass through this layer of inert gas and in doing so are extinguished.

It has also been found particularly preferable to completely vaporise liquid carbon dioxide before or during introducing it into the silo to avoid the formation of solid carbon dioxide. The gaseous carbon dioxide produced during vaporisation penetrates the deposited goods in the silo better and distributes more evenly in the silo than would carbon dioxide snow. Besides, the temperature of carbon dioxide snow is around −79° C. Some parts of the silo, which are usually not designed for such low temperatures, may therefore be damaged through the snow.

The complete vaporization of liquid carbon dioxide has the added benefit of reducing the possibility of electrostatic sparks caused by the presence of solid carbon dioxide.

Liquid carbon dioxide may be vaporised, for example, through supplying heat. However, this variant requires additional heating devices and is therefore relatively elaborate. Preferably, a second gas is added to the liquid carbon dioxide and its heat capacity is used to vaporise the liquid carbon dioxide. Preferably, merging and adding the carbon dioxide stream and the second gas stream occurs through using the Venturi or Coanda effect.

Thus, for example a second, low-pressure gas is sucked into a Venturi nozzle by means of a higher-pressure liquid carbon dioxide. Preferably, ambient air or an inert gas, particularly gaseous carbon dioxide or nitrogen, are used as a second gas. The relation of quantity of liquid carbon dioxide to sucked in gas is preferably between 2:1 and 1:20, particularly preferably 2:1 and 1:2 in relation to the weight and is selected depending on the requirements, the pressure conditions and the embodiment of the Venturi nozzle and the mixing device, respectively.

Usually such Venturi and Coanda devices are employed for mixing two fluid streams. Within the framework of the present invention it has been found that in such devices a particularly good heat transfer between the fluid streams involved occurs and that these may be employed advantageously for vaporising one of the fluid streams.

Preferably, the Venturi or Coanda device, for example a Venturi nozzle, are designed, such that a sufficient amount of the second gas is sucked in to vaporise the liquid carbon dioxide completely. The amount of second gas should, however, not be so large that undesired gas circulations occur in the silo. In order to achieve a distribution as evenly as possible of the carbon dioxide in the silo or on the deposited goods, respectively, the amount of second gas is thus selected such that it is just sufficient for the vaporisation of liquid carbon dioxide and only a minimal excess of the second gas is present. Through this a relatively cold carbon dioxide gas is produced, which distributes evenly across the surface of the deposited goods only with minimal mixing with the combustion gases in the headroom of the silo.

Furthermore, it has been found to be advantageous to measure the concentration of H₂ and/or CO in the headroom of the silo to quantify the danger potential through a smouldering fire. Depending on the measured concentration air or a gas that is lighter than air are introduced into the silo as a flushing gas to dilute the atmosphere in the silo, to lower the H₂ and/or CO concentration and thus reach beyond the explosion limits. Normally, a dilution of combustible gases to less than 1 vol % is sufficient to be able to exclude a danger of explosion. In addition to air all non-combustible and non or only slightly toxic gases are suitable as a flushing gas, particularly nitrogen.

The invention also relates to a silo for storing deposited goods having an inlet for inert gas and a vent for extracting off gas from the silo. According to the invention the inlet for the inert gas and the vent for the off gas are provided in the upper third of the silo and the lower two thirds of the silo have no opening though which air could penetrate into the silo.

According to the invention the silo is closed in the lower part such that access of air is at least to a large extent excluded. The inlet for an inert gas and the vent for off gases or excess inert gas, respectively, are provided in the upper third of the silo. The vent for the off gas is preferably only as big so that the off gases, combustion gases and excess inert gas may be extracted from the silo but air may penetrate the silo in larger quantities.

Preferably, the vent is disposed in the upper 10% of the silo, particularly preferably at the highest point of the silo.

In a preferred embodiment the vent can be closed, particularly the vent is provided with a flap. Preferably the flap is actuated depending on the discovery of a fire in the silo. The flap may for example be activated depending on the measurements of a thermal imaging camera or depending on the H₂ and/or CO content in the headroom of the silo. Since during a fire H₂ appears more quickly in the headroom than CO, H₂ is the better indicator for a danger than CO and therefore preferably the H₂ content is determined in the headroom.

The vent is preferably designed as inert gas sluice. The air oxygen is thus eliminated from the area of the vent of the silo through inert gases. For this a sluice with a port is for example fitted onto the vent, inert gas being fed into the port of the sluice and thus an inert buffer layer is produced. For example an inert gas flow may be produced in a surrounding fissure of the vent, said fissure being diverted radially to the axis of the vent and thus forming a barrier against the penetration of air. Generally inert gas sluice is understood as a vent, in which entry of air through the vent through a suitable supply of inert gas is restricted or prevented. A preferred embodiment of an inert gas sluice is described in DE 102004008395 A1.

The invention has several advantages over earlier processes. Thus, through the supply of inert gas according to the invention the danger of explosion in the silo is clearly lowered. This holds true for dust, biogas and H₂ explosions. The deposited goods remain dry after an extinguishing action according to the invention and can be re-used. The silo does not have to be emptied for extinguishing or even after extinguishing a fire which saves labour, emissions and space and lowers the danger to the surrounding buildings or silos. Also, there is no water damage to the silo. Since the extinguishing gas has only a small weight the statics of the silo are not strained. The system according to the invention may be installed prophylactically, such that in the case of a fire no firemen have to be employed in the immediate surroundings of the silo. The extinguishing gas may be supplied from a safe distance so that even during an explosion no person comes to harm.

What we claim is:

1. A method for extinguishing burning deposited goods situated in a silo, inert gas being introduced into the silo and off gas being extracted from the silo, characterised in that the inert gas being introduced into the silo above the burning deposited goods.

2. The method according to claim 1 characterised in that carbon dioxide is introduced into the silo.

3. The method according to claim 2 characterised in that liquid carbon dioxide is introduced into the silo.

4. The method according to claim 1, characterised in that liquid carbon dioxide is introduced under pressure in a mixing device, particularly a nozzle, and a second gas is sucked into the mixing device according to the Venturi or Coanda principle, and that the liquid carbon dioxide is vaporised in direct heat exchange with the second gas.

5. The method according to claim 1, characterised in that the concentration of H₂ and/or CO is measured in the silo above the deposited goods and depending on the measured concentration air or a gas, which is lighter than air, is introduced into the silo as a flushing gas.

6. The method according to claim 1, characterised in that in the area of the vent an inert gas is supplied such that entry of ambient air through the vent into the silo is substantially lowered.

7. A method for extinguishing burning deposited goods situated in a silo, inert gas being introduced into the silo and off gas being extracted from the silo, characterised in that the off gas being extracted from the silo above the burning deposited goods.

8. The method according to claim 7 characterised in that carbon dioxide is introduced into the silo.

9. The method according to claim 8 characterised in that liquid carbon dioxide is introduced into the silo.

10. The method according to claim 7, characterised in that liquid carbon dioxide is introduced under pressure in a mixing device, particularly a nozzle, and a second gas is sucked into the mixing device according to the Venturi or Coanda principle, and that the liquid carbon dioxide is vaporised in direct heat exchange with the second gas.

11. The method according to claim 7, characterised in that the concentration of H₂ and/or CO is measured in the silo above the deposited goods and depending on the measured concentration air or a gas, which is lighter than air, is introduced into the silo as a flushing gas.

12. The method according to claim 7, characterised in that in the area of the vent an inert gas is supplied such that entry of ambient air through the vent into the silo is substantially lowered.

13. A silo for storing deposited goods having an inlet for inert gas and a vent for extracting off gas from the silo, characterised in that the inlet for the inert gas and the vent for the off gas are provided in the upper third of the silo and in that the lower two thirds of the silo have no opening.

14. The silo according to claim 13, characterised in that the vent can be closed, particularly in that the vent is provided with a flap.

15. The silo according to claims 13, characterised in that in the area of the vent a supply for inert gas is provided.
